(19) United States
(12) Patent Application Publication
(10) Pub. No.: US 2024/0367085 A1
(43) Pub. Date: Nov. 7, 2024

(54) CLEAN-AIR PARTITION SYSTEMS

(71) Applicant: AIRTECH INNOVATIONS PRIVATE LIMITED, Telangana (IN)

(72) Inventor: Srinivasa Rao VUTLA, Telangana (IN)

(21) Appl. No.: 18/683,255

(22) PCT Filed: Aug. 12, 2022
(86) PCT No.: PCT/IN2022/050730

§ 371 Date: Feb. 13, 2024

(30) Foreign Application Priority Data
Aug. 13, 2021 (IN) 202141036817

(51) Int. Cl. B01D 46/44; A62B 23/00; B01D 46/46; E04B 2/74; F24F 8/108; F24F 110/64

(52) U.S. Cl. CPC B01D 46/442; A62B 23/00; B01D 46/46; E04B 2/7405; F24F 8/108; B01D 2273/30; F24F 2110/64

(57) ABSTRACT

The present invention relates to Clean-Air Partition Systems. The system (100) comprises of mainframe (10) including an upper frame (10a) and a lower frame (10b), control panel and display (11), stand (12), plurality of wheels (13), a first high-efficiency particulate air (HEPA) filter (14) placed in the upper frame (10a) of the main frame (10) and a second high-efficiency particulate air (HEPA) filter (15) placed in lower frame (10b) of the main frame (10), an Airflow Separation Module (ASM) (16); and Smart Particle Sensor Actuator Set (SPSAS) (17a, 17b). The design and methodology of construction of system (100) structure is fitted with high-efficiency particulate air (HEPA) filters (14, 15). The high-efficiency particulate air (HEPA) filters are fitted on both the front-end and read-end of the system. The aim of the present invention is to provide low-cost, convenient clean-air partition systems for protection against contraction of infectious diseases.

### RELATED PATENT APPLICATION(S)

This application claims the priority to and benefit of Indian Provisional Patent Application No. 202141036817 filed on Aug. 13, 2021; the disclosures of which are incorporated herein by reference.

### FIELD OF THE INVENTION

The present invention relates to air partition system. Particularly the present invention relates to Clean-Air Partition Systems. More particularly the present invention relates to design, construction, and use of Clean-Air Partition Systems as Controlled Clean-Air-Flow Separation and Controlled Clean-Air-Flow Isolation systems for Infection-Prevention. The invention is in particular addressed to health workers including medical doctors and nurses, in general for any individuals disposed in conditions demanding suitable protection against various diseases.

### BACKGROUND OF THE INVENTION

The air-borne virus causing type diseases have attacked humans at regular intervals over centuries but more noteworthy are the Flu, and more recently the deadly Corona virus. There is obvious and compulsive need for citizens of several sections of the society, who cannot completely suspend their professional work to maintain social distancing to prevent themselves from such diseases. They include the medical doctors, nurses, other health workers, and certain others type of workers in industrial and medical sectors. These citizens must continue to work by using whatever best possible protection against contraction of disease.

World-over, several organizations on war-footed basis have come up with a variety of protection equipment, ranging from a simple facemask to more elaborate personal protection equipment (PPE) systems. The facemask is a simple, inexpensive, and often reusable element protection but it is good for only common individual moving in less infectious environments. However, they cannot offer protection for individuals who must meet in any given day a large number of Covid patients, patients with other diseases or persons needing other interactions such as in banks, counselling centers, airport help centers etc. The PPE is more suitable for protection in these more risky environments than a facemask. However, a PPE system also faces some problems such as it is very cumbersome, acts as a barrier to the natural need of visage, gesture and verbal based communication. Moreover, the PPE proves to be a very expensive proposition for continued usage as some of its parts in need costly replacement, high quality washing, and complete disposal.

Further, another way to prevent the individuals from such deadly diseases is purifying the room air.

However, the existing room air-purifiers comprise of certain drawbacks as if they are focused more on dust particle sensors and blower fans actuated by the signals from these sensors, disposing air in plurality of directions, or designed to circulate the air in a room by usual exchange of outside air. They do not provide controlled clear air supply to a selected mini-environment.

The Chinese Patent Application CN105980031A provide an air cleaner that controls increase in electricity consumed and noise and can sufficiently eliminate fine particles in air. The air cleaner is provided with a blown air passage linking with a suction inlet for sucking in air and discharge openings for discharging air, a blower disposed within the blown air passage, a filter unit provided in the blown air passage for collecting dust in the air and a dust sensor for detecting dust in the air, and that varies the rotational speed of the blower to a plurality of different blower levels on the basis of a plurality of degrees of contamination. The concentration of fine particles smaller than a prescribed particle size that are included in the dust in the air is extracted from detection results from the dust sensor, and when the concentration of fine particles is higher than the prescribed degree of contamination, the blower level is further increased over that when the same as low and the rotational speed of the blower is set higher. It mainly focuses on dust particle sensors and blower fans actuated by the signals from these sensors.

Another Chinese Patent Application CN111804085A provides an air purifier for disposing air in plurality of directions. An air purifier includes a housing; a blower unit installed in the housing to suck external air; and a filter unit having a filtering surface through which air passes and which is disposed in a plurality of directions, and an air inflow space at least a portion of which is surrounded by the filtering surface disposed in the plurality of directions and into which air discharged from the blower unit flows.

Moreover, the existing purifiers are either horizontal wall-fitted or meant for a fixed location, huge weight, and high in cost. Thus, to overcome the said drawbacks, the present invention provides a completely portable low-weight vertical tower system that can be located anywhere near the controlled mini-environment. Further, the said system is cost economic and convenient clean-air partition systems for protection against contraction of infectious diseases that spread through air-borne viruses.

### OBJECTS OF THE INVENTION

The primary object of the present invention is to provide Clean-Air Partition Systems.

Another object of the present invention is to provide a Controlled Clean-Air-Flow Separation Infection-Prevention System (CCSIS).

Another object of the present invention is to provide a Controlled Clean-Air-Flow Isolation Infection-Prevention System (CCIIS).

Another object of the present invention is to provide the design, construction, and products of Clean-Air Partition Systems such as CCSIS and CCIIS.

Yet another object of the present invention is to provide a Clean-Air Partition System which is convenient and easy for installation wall system.

Another object of the present invention is to provide use of Clean-Air Partition Systems such as CCSIS and CCIIS and products thereof in protection against various diseases.

Another object of the present invention is to provide a system to separate the clean and infected air streams, and direct the infected air towards the exhaust HEPA and bring in the clean air through the dedicated zone into the protected space.

Another object of the present invention is to provide a system which helps in maintain the region of space clean with a unidirectional flow of clean air so that the protected person is at no risk of inhaling the virus while interacting with a possibly infected visitor, who may be using verbal and gestural communication.

Yet a further object of the present invention is to provide a low-cost, convenient clean-air partition systems for protection against contraction of infectious diseases that spread through air-borne viruses, and in particular against the spread of Corona, Flu and related diseases.

### SUMMARY OF THE INVENTION

Accordingly, the present invention provides Clean-Air Partition Systems. The said Clean-Air Partition System is convenient and easy for installation wall system. Further, the said system separates the clean and infected air streams, and direct the infected air towards the exhaust HEPA filter and bring in the clean air through the dedicated zone into the protected space. Also, the system helps in maintaining the region of space clean with a unidirectional flow of clean air so that the protected person is at no risk of inhaling the virus while interacting with a possibly infected visitor, who may be using verbal and gestural communication.

The provided system is a low-cost, convenient clean-air partition systems for protection against contraction of infectious diseases that spread through air-borne viruses, and in particular against the spread of Corona, Flu and related diseases.

In one embodiment, the present invention provided a Clean Air-Partition System (100) comprising:
a main frame (10) including a upper frame (10a) and a lower frame (10b);
a control panel and display (11) mounted on top of system (100) in the main frame (10);
a stand (12);
plurality of wheels (13);
a first high-efficiency particulate air (HEPA) filter (14) placed in the upper frame (10a) of the main frame (10) and a second high-efficiency particulate air (HEPA) filter (15) placed in lower frame (10b) of the main frame (10);
an Airflow Separation Module (ASM) (16); and
Smart Particle Sensor Actuator Set (SPSAS) (17a, 17b),
wherein the upper frame (10a) is either fixed in location above the lower frame (10b) or adjustable manually or automatically;
wherein the Airflow Separation Module (ASM) (16) separates a clean airflow streams (B) and an unclean airflow streams (A), direct the clean air towards a user, direct the unclean air downwards into the exit HEPA filter (14, 15) and bring in the clean air through the dedicated frame into the protected space, and
wherein the SPSAS (17a, 17b) senses and provides the biological marking of the particles in terms of their toxicity in different vertical panels to the electronic display placed in the control panel (11), actuates a drive box to move the upper frame (10a) to maintain the flow separation and suit the height of the system (100) to the specific case and switch on/off the two HEPA filters (14, 15) in the upper frame (10a) and lower frame (10b) to maintain a volume flow rate and direction of flow of air through the HEPA filters (14, 15).

In one example embodiment, one of the two frames (10a, 10b) acts as inlet port or suction port for the unclean/infected air (A) and the other act as outlet or blower for clean air (B).

The system (100) can be manually and/or automatically adjusted and achieve separation of flow of clean air streams (B) from the unclean air streams (A) and maintain both the protected space and outside space clean.

The system (100) is fixed or portable, employ to automatically or manually create and maintain a clean climate in environment and can be permanently fixed at the time of construction of the room or retrofitted into an existing environment.

The system (100) is capable of directing virus-borne air away from the protected zones and filling the zone with non-toxic and healthy air.

The system (100) is a designed structure to enclose the HEPA filters (14, 15) along with the implementation for flow separation, the facility to translate or rotate the structure on the ground, and necessary electrical connections for power input.

An airflow separation implementation in the system (100) enables the flow in the targeted and limited region of space of clean air into two or more streams in the vertical plane.

The said system maintains the region of space clean with a unidirectional flow of clean air so that the protected person is at no risk of inhaling the virus while interacting with a possibly infected visitor when the protected person is in verbal and gestural communication with the possibly infected visitor.

In one embodiment, the present invention provides a Controlled Clean-Air-Flow Separation Infection-Prevention System (CCSIS). The Controlled Clean-air-flow Separation Infection-prevention System (CCSIS) comprising one or more Clean Air-Partition System (100) as claimed in claims 1-8, wherein the Clean Air-Partition System (100) comprising:
a main frame (10) comprising of a upper frame (10a) and lower frame (10b);
a control panel and display (11) mounted on top of system (100) in the main frame (10);
a stand (12);
plurality of wheels (13);
a first high-efficiency particulate air (HEPA) filter (14) placed in the upper frame (10a) of the main frame (10) and a second high-efficiency particulate air (HEPA) filter (15) is placed in lower frame (10b) of the main frame (10);
an Airflow Separation Module (ASM) (16); and
Smart Particle Sensor Actuator Set (SPSAS) (17a, 17b),
wherein the Airflow Separation Module (ASM) (16) separates the clean airflow streams (B) and unclean airflow streams (A), direct a clean air towards a user and direct an unclean air downwards into the exit HEPA filter (14, 15) and bring in the clean air through the dedicated frame into the protected space, and
wherein the SPSAS (17a, 17b) senses and provides the biological marking of the particles in terms of their toxicity in different vertical panels to the electronic display placed in the control panel (11), actuates the drive box to move the upper frame (10a) to maintain the flow separation and suit the height of the system (100) to the specific use case and switch on/off the two HEPA filters (14, 15) in the upper frame (10a) and lower frame (10b) to maintain a volume flow rate and direction of flow of air through the HEPA filters (14, 15).

In another embodiment, the present invention provides a Controlled Clean-Air-Flow Isolation Infection-Prevention System (CCIIS). A Controlled Clean-air-flow Isolation Infection-prevention System (CCIIS) comprising:
a Clean Air-Partition System (100) as claimed in claims 1-8;
a transparent thick polymer sheet enclosure (22); and
a metal frame (23).

The above description merely is an outline of the technical solution of the present disclosure; in order to know the technical means of the present disclosure more clearly so that implementation may be carried out according to contents of the specification, and in order to make the above and other objectives, characteristics and advantages of the present disclosure more clear and easy to understand, specific embodiments of the present invention will be described in detail below.

### BRIEF DESCRIPTION OF DRAWINGS

The foregoing and other features of embodiments will become more apparent from the following detailed description of embodiments when read in conjunction with the accompanying drawings. In the drawings, like reference numerals refer to like elements. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

FIG. 1 shows prototype design of Clean-air-flow partition system (100) of the present invention.

FIG. 2 shows schematic front and side views of the system (100) of FIG. 1.

FIGS. 3a-3d shows various example embodiments of system (100) of FIG. 1 based on the flows of the infected air (A) and cleaned air (B).

FIG. 4 shows the working concept along with an example embodiment of the CCSIS.

FIG. 5 shows the working concept along with another example embodiment of CCSIS for isolating the air-zone of a rested patient.

FIG. 6 shows yet another embodiment of CCSIS protecting a single worker located in infectious environment.

FIG. 7 shows Controlled Clean-Air-Flow Isolation Infection-Prevention System (CCIIS).

### DESCRIPTION OF THE INVENTION

Accordingly, the present invention provides Clean-Air Partition Systems. More particularly the present invention provides design, construction, and use of Clean-Air Partition Systems as Controlled Clean-Air-Flow Separation and Controlled Clean-Air-Flow Isolation systems for Infection-Prevention. The invention is in particular addressed to health workers including medical doctors and nurses, in general for any individuals disposed in conditions demanding suitable protection against various diseases.

As mentioned above, the existing purifiers are either horizontal wall-fitted or meant for a fixed location, huge weight, and high in cost. The present invention overcomes the said drawbacks and provides a completely portable low-weight vertical tower system that can be located anywhere near the controlled mini-environment. Further, the said system is cost economic and convenient clean-air partition systems for protection against contraction of infectious diseases that spread through air-borne viruses.

The invention mainly covers a cost economic and convenient clean-air partition systems called as Controlled Clean-air-flow systems (CCs) for in general protection against the contraction of infectious diseases that spread through air-borne viruses, including Covid, Flu, and related diseases. The mechanical system and the sequenced process of the system employ to automatically or manually create and maintain a clean climate in a work or leisure environment of a room or a tent in open fields. These system can be permanently fixed at the time of construction of the room or retrofitted into an existing room or a tent. They can be either fixed or portable. They contain a scientifically designed collection of air-filters, fans, airflow directing vanes and channels, and sensors into a system capable of both directing away virus-borne air away from the protected zones and filling the zone with non-toxic and healthy air. We collectively call these devices the “Controlled Clean-air-flow systems, abbreviated as “CCs”. The said CCs comprises:
An airflow separation implementation that enables the flow, in the targeted and limited region of space, of clean air into two or more streams in the vertical plane.
One or more high-efficiency particulate air (HEPA) filters fitted on both the front-end and read-end.
A specifically designed structure that encloses the HEPA filters and the technological implementation for flow separation, the facility to translate or rotate the structure on the ground and necessary electrical connections for power input.

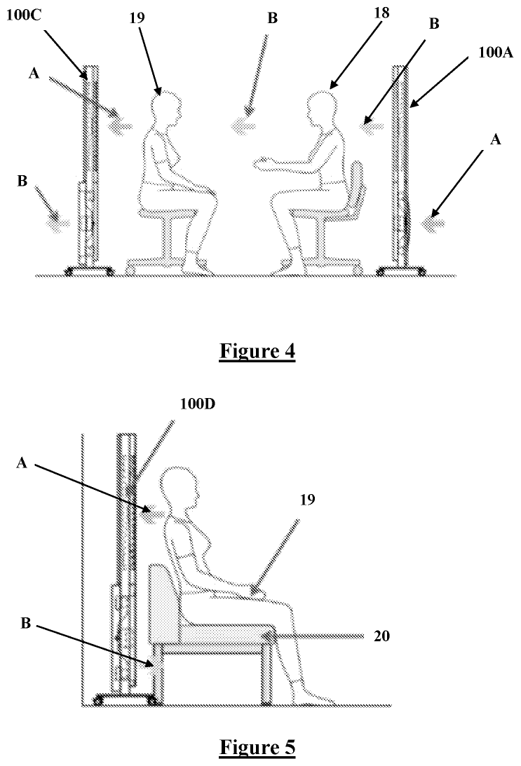

The invention is briefly divided into two categories wherein the first category of the invention is a “Controlled Clean-air-flow Separation Infection-prevention System (CCSIS)” and the second category is the “Controlled Clean-air-flow Isolation Infection-prevention System (CCIIS)”. Both CCSIS and CCIIS uses the Clean Air-Partition System of the present invention. The specific steps of operational sequences adapted to the different use cases along with different configurations of the system differentiate the CCSIS and CCIIS. The “Controlled Clean-air-flow Separation Infection-prevention System (CCSIS)” refers to the system where the Clean Air-Partition System of the present invention is used to create a mini controlled environment. For example, when two Clean Air-Partition System of the present invention are mounted in front of each other at a particular distance, the environment created in between can be referred as “Controlled Clean-air-flow Separation Infection-prevention System (CCSIS)” (as shown in FIG. 4-6). Further, when additional components are used with the Clean Air-Partition System like in hospitals in case of a bedded patient, a separate environment can be created around a patient's bed using additional metal frames and transparent thick polymer sheet enclosure to isolate the air zone of the patient. This can be referred as the “Controlled Clean-air-flow Isolation Infection-prevention System (CCIIS)” (FIG. 7). Details regarding both the systems are explained herein in the later part.

In one aspect of the present invention, the present invention provides Clean Air-Partition Systems. The systems i.e. CCSIS and CCIIS works on a similar general principle. It mainly involves separating the clean and inflected air streams, and direct the infected air towards the exhaust HEPA filter and bring in the clean air through the dedicated zone into the protected space. The principle in the CCSIS and CCIIS is achieved with the combination of designed vertical tower system comprising two HEPA filters where direction of airflow is controlled by a Smart Particle Sensor Actuator Set (SPSAS) and designed Airflow Separation Module (ASM). The specific steps of operational sequences adapted to the different use cases differentiate the CCSIS and CCIIS. The following description of design and smart operation methodology are common to both CCSIS and CCIIS. The lower zone of the CCSIS and CCIIS consists of similar set of devices and is fixed to the stand of the structure.

The CCs is either a stand-alone or wall mountable vertical tower systems consisting of several designed features and components. It consists of two zones. The upper zone consists of a HEPA, a Smart Particle Sensor Actuator Set (SPSAS) and is vertically movable for height adjustment. The upper zone may be either fixed in location above the lower zone or adjustable manually or automatically. The SPSAS serves multiple functions. It senses and provides the biological marking of the particles in terms of their toxicity to an electronic display. It actuators the drive box to move the upper zone to appropriate level for each use condition. The SPSAS is also capable of switching on/off to maintain a volume flow rate as well as direction of flow of air through the HEPA filters.

The Airflow Separation Module (ASM) is a designed airflow separation system whose external geometry has been designed based on the principles of computational fluid dynamics (CFD) for mixture flow model and computer aided design (CAD) of surfaces. Its external geometry initiates the separation airflow into two zones, clean stream zone and unclean stream zone and directs the streams accordingly towards the protected persons and HEPA filters.

The said system helps in maintaining the region of space clean with a unidirectional flow of clean air so that the protected person is at no risk of inhaling the virus while interacting with a possibly infected visitor, who may be using verbal and gestural communication.

The system is a designed structure to enclose the HEPA filters (14, 15) along with the implementation for flow separation, the facility to translate or rotate the structure on the ground, and necessary electrical connections for power input.

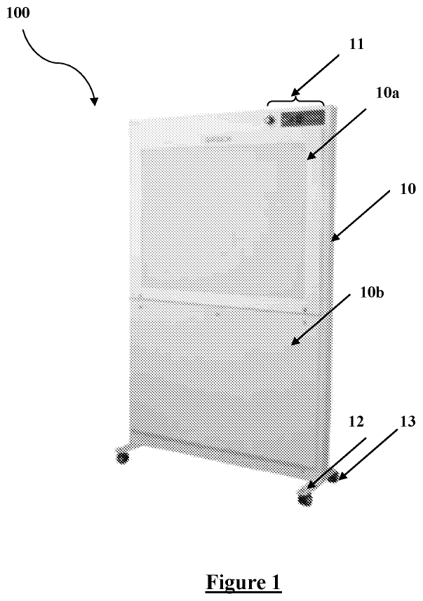

### FIG. 1:

Referring to FIG. 1 of the present invention, the FIG. 1 shows the prototype design of the Clean Air Partition System which is referred as (100) in which the idea is to separate the airflow into two streams in the vertical plane and into a limited region of space. The region of space is maintained clean with a unidirectional flow of clean air so that the protected person is at no risk of inhaling the virus while interacting with a possibly infected visitor, who may be using verbal and gestural communication.

The said system (100) comprises of a main frame (10). The said main frame (10) is divided into two parts i.e. upper frame (10a) and lower frame (10b). The main frame (10) is mounted on a stand (12) where the stand is fitted with wheels (13) on all the four sides for easy movement of the system (100). The wheels (13) helps the system for easy transport from one place to another and makes the system (100) portable. Further, controller panel and display (11) is mounted on top of system in the main frame (10). The controller panel (11) mainly provides the user with a speed adjustment nob to adjust the airflow from the system (100) along with the ON/OFF switch. Further, the biological marking of the particles in terms of their toxicity is displayed using an electronic display mounted on the control panel. The design of the controller panel can be any available design performing the above said functions.

### FIG. 2:

Referring FIG. 2 of the present invention, FIG. 2 shows the schematic front and side views of the system (100) of FIG. 1. The design and methodology of construction of system (100) is structure fitted with high-efficiency particulate air (HEPA) filters (14, 15) which are crucial feature in the present invention. The system (100) mainly involves separating the clean and inflected air streams, and direct the infected air towards the exhaust HEPA filter (14, 15) and bring in the clean air through the dedicated frame into the protected space. The principle in the system (100) is achieved with the combination of designed vertical tower system comprising two HEPA filters (14, 15) wherein the first HEPA filter (14) is placed in the upper frame (10a) of the main frame (10) and second HEPA filter (15) is placed in lower frame (10b) of the main frame (10). The direction of airflow is controlled by a Smart Particle Sensor Actuator Set (SPSAS) (17a, 17b) and designed Airflow Separation Module (ASM) (16). The Smart Particle Sensor Actuator Set (SPSAS) (17) are place at four corner of the frames (10a and 10b).

The CCs/system (100) is either a stand-alone or wall mountable vertical tower systems consisting of several designed features and components. The upper frame (10a) consists of a HEPA filter (14), a Smart Particle Sensor Actuator Set (SPSAS) (17a) and is vertically movable for height adjustment. The upper frame (10a) may be either fixed in location above the lower frame (10b) or adjustable manually or automatically. The lower frame (10b) consists of a HEPA filter (15) and a Smart Particle Sensor Actuator Set (SPSAS) (17b).

The SPSAS (17a, 17b) serves multiple functions. The SPSAS (17a, 17b) senses and provides the biological marking of the particles in terms of their toxicity in different vertical panels to the electronic display placed in the control panel (11). Further, it actuates the drive box to move the upper frame (10a) to maintain the flow separation and suit the height of the system (100) to the specific use case. The SPSAS (17a, 17b) is also capable to switch on/off the two HEPA filters (14, 15) in the upper frame (10a) and lower frame (10b) to maintain a volume flow rate and direction of flow of air through the HEPA filters (14, 15).

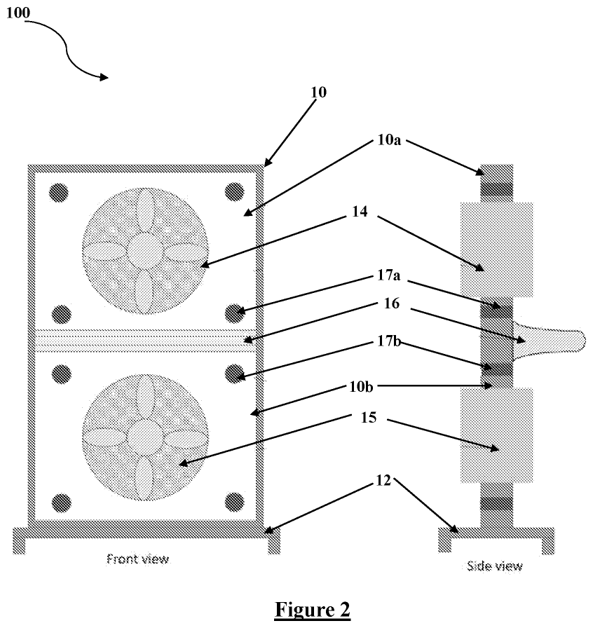

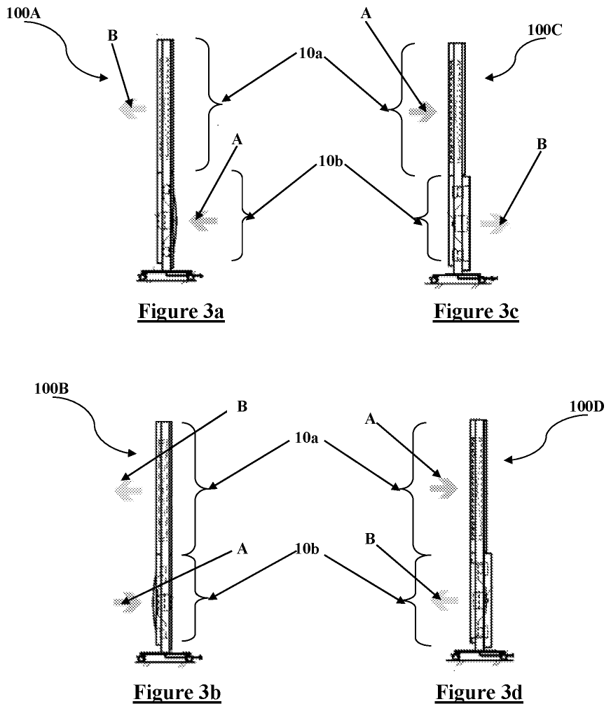

The Airflow Separation Module (ASM) (16) is a designed airflow separation system whose external geometry has been designed based on the principles of computational fluid dynamics (CFD) for mixture flow model and computer aided design (CAD) of surfaces. Its external geometry initiates the separation airflow into two frames (10a, 10b), clean stream zone (denoted by B in FIGS. 3-6) and unclean stream zone (denoted by A in FIGS. 3-6) and directs the stream accordingly towards the protected persons and HEPA filters (14, 15). The Airflow Separation Module (ASM) (16) separates the clean airflow streams (B) and unclean airflow streams (A), direct the clean air towards a user and direct the unclean air downwards into the exit HEPA filter (14, 15) and bring in the clean air through the dedicated frame into the protected space.

FIGS. 3a-3d:

As mentioned above, the main frame (10) of the system (100) is divided into two parts i.e. upper frame (10a) comprising a first HEPA filter (14) and lower frame (10b) comprising second HEPA filter (15). In general embodiment, one of the two frames (10a, 10b) acts as inlet port or suction port for the infected air denoted by arrow (A) and the other act as outlet or blower for clean air denoted by arrow (B). As described, any of the upper frame (10a) or lower frame (10b) can act as an inlet for infectious air and the other act as outlet for the clean air. Thus, based on the same combinations, referring to FIG. 3a to FIG. 3d of the present invention, the present invention provides various embodiments of the system (100) in different configurations.

In one embodiment configuration, referring FIGS. 3(a) and 3(b), in the system (100A) of FIG. 3a and the system (100B) of FIG. 3b, the clean air blower along with HEPA filter (14) is mounted in the upper frame (10a) and the suction device with HEPA filter (15) is mounted in the lower frame (10b). Thus, the infected air is sucked by the suction device in the lower frame (10b) and clean air is released from the blower mounted in the upper frame (10a).

Further, in one example embodiment configuration of system (100) referred as configuration (I), in the system (100A) the suction device in the lower frame (10b) and the blower in the upper frame (10a) are placed on opposite side of the system. Thus, as shown in FIG. 3a, the infected air (A) is sucked from the lower portion of said system (100A) and clean air (B) is released from the upper portion of the system (100A) in opposite side from where the infected air was sucked.

In another example embodiment configuration of system (100) referred as configuration (II), in the system (100B) the suction device in the lower frame (10b) and the blower in the upper frame (10a) are placed on same side of the system. Thus, as shown in FIG. 3b, the infected air (A) is sucked from the lower portion of said system (100B) and clean air (B) is released from the upper portion of the system (100B) in same side from where the infected air was sucked.

Furthermore, in one embodiment configuration, referring FIGS. 3(c) and 3(d), in the system (100C) of FIG. 3c and the system (100D) of FIG. 3d, the suction device with HEPA filter (15) is mounted in the upper frame (10a) and the clean air blower along with HEPA filter (14) is mounted in the lower frame (10b). Thus, the infected air is sucked by the suction device in the upper frame (10a) and clean air is released from the blower mounted in the lower frame (10b).

In another example embodiment configuration of system (100) referred as configuration (III), in the system (100C) the suction device in the upper frame (10a) and the blower in the lower frame (10b) are placed on opposite side of the system. Thus, as shown in FIG. 3c, the infected air (A) is sucked from the upper portion of said system (100C) and clean air (B) is released from the lower portion of the system (100C) in opposite side from where the infected air was sucked.

Yet, in another example embodiment configuration of system (100) referred as configuration (IV), in the system (100D) the suction device in the upper frame (10a) and the blower in the lower frame (10b) are placed on same side of the system. Thus, as shown in FIG. 3d, the infected air (A) is sucked from the upper portion of said system (100D) and clean air (B) is released from the lower portion of the system (100D) in same side from where the infected air was sucked.

Thus, based upon the positions of blower and suction device in the system and based upon the directions of the airflows, the said system 100 can be configured into above-mentioned four configurations i.e. 100A, 100B, 100C and 100D.

### FIG. 4

Now, referring to FIG. 4, FIG. 4 shows the working concept along with an example embodiment of the Controlled Clean-air-flow Separation Infection-prevention System i.e. CCSIS. As mentioned above, the CCSIS uses the Clean Air-Partition System (100). The “Controlled Clean-air-flow Separation Infection-prevention System (CCSIS)” refers to the system where the Clean Air-Partition System (100) is used to create a mini controlled environment as shown in FIG. 4. The Controlled Clean-air-flow Separation Infection-prevention System (CCSIS) may include one or more Clean Air-Partition Systems (100).

In one embodiment, as seen in the figure, the two Clean Air-Partition Systems (100) one in configuration-I (100A) and other in configuration-III (100C) are mounted in front of each other at a predefined distance. The arrangement creates a mini controlled environment. As shown in the figure, the region of space is maintained clean with a unidirectional flow of clean air so that the protected person is at no risk of inhaling the virus while interacting with a possibly infected visitor, who may be using verbal and gestural communication. Considering the above arrangement is placed in doctor's cabin, where a doctor (18) is treating a patient (19). The design and methodology of construction of CCSIS structure fitted with high-efficiency particulate air (HEPA) filters are crucial in the present invention. The other critical part is the implementation of the lower stream of airflow (A) and maintaining a unidirectional high-speed airflow in the upper stream (B), which are ensured to flow continuously from the doctor (18) (protected person) towards the patient (19), together enabling the main functionality of the CCSIS.

The general specification of the Controlled Clean-Air-Flow Separation Infection-Prevention System (CCSIS) includes:
0.3 μm particle filtration
HEPA filter (99.99% filtration)
Air velocity≅0.5 m/sec
Air volume≅14 m³/min
Power supply includes AC220V, 1Φ, 50 Hz supply.
Power consumption≅90W
Weight≅50 kg.

The infected air (A) flow from outside of the controlled mini-environment through the lower frame of system (100A), passed through the partition system (100A), is purified in the system (100A) and then blow out as clean air (B) from the upper frame of the system (100A) in the mini controlled environment. The clean air (B) flows form the doctor (18) to the patient (19). If any virus or contamination is present in the patient's side, the said infected air (A) is sucked the upper frame of system (100C), passed through the partition system (100C), is purified in the system (100C) and then blow out as clean air (B) from the lower frame of the system (100C) outside the mini controlled environment.

### FIG. 5:

FIG. 5 presents another example use case of the CCSIS, in which infected patient (19) seated or rested in chair beds (20) can be effectively isolated in the limited air zone that the patient occupies. In the example, system (100) in configuration type IV (100D) is used. Considering the seated patient (19) is infected and the air surrounding the patient (19) is also infected. In this example, the infected air (A) is sucked the upper frame of system (100D), passed through the partition system (100D), is purified in the system (100D) and then blow out as clean air (B) from the lower frame of the system (100D) in the same side of the system. Thus, using the system (100) in configuration type IV the environment surrounding the infected patient (19) seated or rested in chair beds (20) can be effectively isolated in the limited air zone that the patient occupies. In this embodiment, when the patients coughs or sneezes, this arrangement insures that the contamination air spread is minimum in the surrounding and it filters the air and releases the clean air.

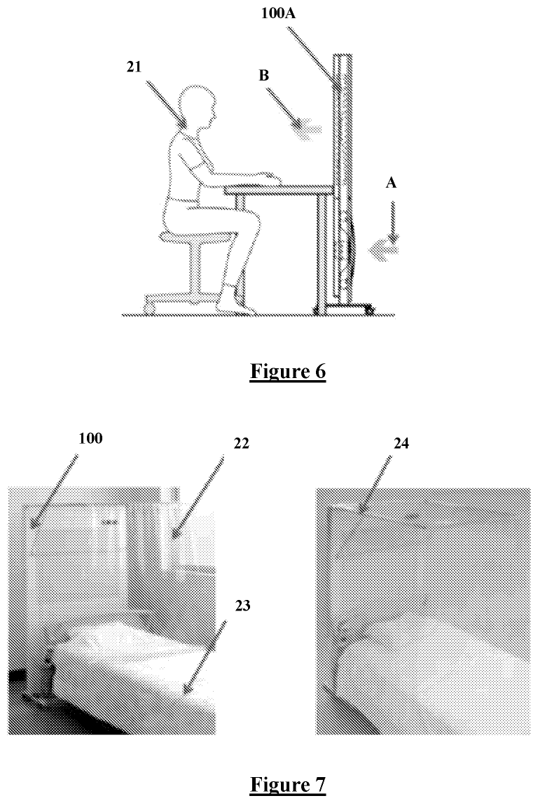

### FIG. 6:

FIG. 6 shows another example user case of CCSIS protecting a single worker located in an infectious environment. Often the workers needs to provide a physical presence in office or hospital spaces for on-hand availability in support. In such cases, the worker (21) cannot perform the work from home (WFM). Instead, they must sit in the office at their individual or collective desks, exposed to an infectious environment. The CCSIS is also a solution for such use cases (FIG. 6), where under steady-state flow conditions, the air zone belonging to the worker (21) and worker's desk is maintained as a virtual separation zone in which the air quality is held to be highly clean by blowing the clean air (B). This is achieved by using the system (100) in configuration type-I. The infected air (A) is sucked from the lower frame of system (100A), passed through the partition system (100A), is purified in the system (100A) and then blow out as clean air (B) from the upper frame of the system (100A) in the opposite side of the system. The system is a cost effective way to protect the health workers at their working table and also ensures that the filtered air is available in close vicinity of the user.

### FIG. 7:

FIG. 7 shows another category of the clean air partition system (100) i.e. the Controlled Clean-Air-Flow Isolation Infection-Prevention System (CCIIS). As mentioned above, when additional components are used with the Clean Air-Partition System (100) like in hospitals in case of a bedded patient, a separate environment can be created around a patient's bed using additional rods and transparent thick polymer sheet enclosure to isolate the air zone of the patient. This can be referred as the “Controlled Clean-air-flow Isolation Infection-prevention System (CCIIS)”. FIG. 7 shows the concept of CCIIS, which is specifically meant for patients in a bedded condition. The cost-effective solution of CCIIS works on the principle of airflow isolation, wherein a cost-effective and transparent thick polymer sheet enclosure (22) isolates the air zone of the patient. The air zone of the patient is maintained at high levels of cleanliness using an enclosed clean partition system (100) placed at the rear end, which forms a crucial part of the present invention. The bed (23) is provided with metal frame (24) on which the transparent thick polymer sheet enclosure (22) is placed thus, isolating the patient from outer environment and creating an isolated air zone of the patient maintained at high levels of cleanliness.

### Advantages

The following are the advantages of the embodiment of present invention:
In the invention provides low-cost, convenient clean-air partition systems for, in general, protection against contraction of infectious diseases that spread through air-borne viruses, and in particular against the spread of Corona, flu, and related diseases.
In the system (100), the HEPA filter-fitted air purifier forms a vertical towers, that form the crucial part of the present invention, along the lower stream of airflow, and maintaining a unidirectional high-speed air-flow in the upper stream always from the worker towards the patient, together enable main functionality of the CCSIS.
In case of the hospital, when the patients coughs or sneezes, this arrangement insures that the contamination air spread is minimum in the surrounding and it filters the air and releases the clean air.
The CCSIS category of the present invention as used by the individual who needs to sit in the office quarters at their individual or collective desks, in this case, under steady-state flow conditions, the air-zone belonging to the worker and worker's desk are maintained as a virtual separation zone in which the air quality is maintained to be highly clean.
The system is a cost effective way to protect the health workers at their working table and ensures that the filtered air is available in close vicinity of the user.
The mechanical devices and the sequenced process of the system (100) employ to automatically or manually create and maintain a clean climate in a work or leisure environment of a room or a tent in open fields.
The system (100) can be permanently fixed at the time of construction of the room or retrofitted into an existing room or a tent.
They can be either fixed or portable.
The system (100) is capable of both directing away virus-borne air away from the protected zones and filling the zone with non-toxic and healthy air.

### LIST OF REFERENCE NUMERALS

100—Clean Air-Partition System
100A—Clean Air-Partition System in type I configuration
100B—Clean Air-Partition System in type II configuration
100C—Clean Air-Partition System in type III configuration
100D—Clean Air-Partition System in type IV configuration
10—Main frame
10a—Upper frame
10b—Lower frame
11—Control Panel and Display
12—Stand
13—Wheels
14—HEPA filter fitted in upper frame
15—HEPA filter fitted in lower frame
16—Airflow Separation Module (ASM)
17a—Smart Particle Sensor Actuator Set (SPSAS) in upper frame
17b—Smart Particle Sensor Actuator Set (SPSAS) in lower frame
18—Doctor
19—Patient
20—Chair
21—User/worker
22—Transparent thick polymer sheet enclosure
23—Hospital Bed
24—Metal frame
A—Infected Air flow
B—Clean airflow.

1. A Clean Air-Partition System comprising:
a main frame including a upper frame and a lower frame;
a control panel and display mounted on top of system in the main frame;
a stand;
plurality of wheels;
a first high-efficiency particulate air (HEPA) filter placed in the upper frame of the main frame and a second high-efficiency particulate air (HEPA) filter placed in lower frame of the main frame;
an Airflow Separation Module (ASM); and
Smart Particle Sensor Actuator Set (SPSAS),
wherein the upper frame is either fixed in location above the lower frame or adjustable manually or automatically;
wherein the Airflow Separation Module (ASM) separates a clean airflow streams and an unclean airflow streams, direct the clean air towards a user and direct the unclean air downwards into the exit HEPA filter and bring in the clean air through the dedicated frame into the protected space, and
wherein the SPSAS senses and provides the biological marking of the particles in terms of their toxicity in different vertical panels to the electronic display placed in the control panel, actuates a drive box to move the upper frame to maintain the flow separation and suit the height of the system to the specific case and switch on/off the two HEPA filters in the upper frame and lower frame to maintain a volume flow rate and direction of flow of air through the HEPA filters.

2. The system as claimed in claim 1, wherein one of the two frames acts as inlet port or suction port for the unclean/infected air and the other act as outlet or blower for clean air.

3. The system as claimed in claim 1, wherein the system can be manually and/or automatically adjusted and achieve separation of flow of clean air streams from the unclean air streams and maintain both the protected space and outside space clean.

4. The system as claimed in claim 1, wherein the system is fixed or portable, employ to automatically or manually create and maintain a clean climate in environment and can be permanently fixed at the time of construction of the room or retrofitted into an existing environment.

5. The system as claimed in claim 1, wherein the system is capable of directing virus-borne air away from the protected zones and filling the zone with non-toxic and healthy air.

6. The system as claimed in claim 1, wherein the system is a designed structure to enclose the HEPA filters along with the implementation for flow separation, the facility to translate or rotate the structure on the ground, and necessary electrical connections for power input.

7. The system as claimed in claim 1, wherein an air-flow separation implementation in the system enables the flow in the targeted and limited region of space of clean air into two or more streams in the vertical plane.

8. The system as claimed in claim 1, wherein the said system maintains the region of space clean with a unidirectional flow of clean air so that the protected person is at no risk of inhaling the virus while interacting with a possibly infected visitor when the protected person is in verbal and gestural communication with the possibly infected visitor.

9. A Controlled Clean-air-flow Separation Infection-prevention System (CCSIS) comprising one or more Clean Air-Partition System as claimed in claim 1, wherein the Clean Air-Partition System comprising:
a main frame comprising of a upper frame and lower frame;
a control panel and display mounted on top of system in the main frame;
a stand;
plurality of wheels;
a first high-efficiency particulate air (HEPA) filter placed in the upper frame of the main frame and a second high-efficiency particulate air (HEPA) filter placed in lower frame of the main frame;
an Airflow Separation Module (ASM); and
Smart Particle Sensor Actuator Set (SPSAS),
wherein the Airflow Separation Module (ASM) separates a clean airflow streams and an unclean airflow streams, direct the clean air towards a user and direct the unclean air downwards into the exit HEPA filter and bring in the clean air through the dedicated frame into the protected space, and
wherein the SPSAS senses and provides the biological marking of the particles in terms of their toxicity in different vertical panels to the electronic display placed in the control panel, actuates the drive box to move the upper frame to maintain the flow separation and suit the height of the system to the specific use case and switch on/off the two HEPA filters in the upper frame and lower frame to maintain a volume flow rate and direction of flow of air through the HEPA filters.

10. A Controlled Clean-air-flow Isolation Infection-prevention System (CCIIS) comprising:
a Clean Air-Partition System as claimed in claim 1;
a transparent thick polymer sheet enclosure; and
a metal frame.
